(19) United States
(12) Patent Application Publication
(10) Pub. No.: US 2025/0036763 A1
(43) Pub. Date: Jan. 30, 2025

(54) RAPID MALWARE SCANNING USING VALIDATED REPUTATION CACHE

(71) Applicant: VMware LLC, Palo Alto, CA (US)

(72) Inventor: SHIRISH VIJAYVARGIYA, Pune (IN)

(21) Appl. No.: 18/377,768

(22) Filed: Oct. 7, 2023

(30) Foreign Application Priority Data
Jul. 24, 2023 (IN) 202341049836

(51) Int. Cl. G06F 21/56; G06F 11/14

(52) U.S. Cl. CPC G06F 21/566; G06F 11/1469; G06F 2201/815; G06F 2221/034

(57) ABSTRACT

A computerized method of restoring a malware-infected computing device using a validated reputation cache includes creating a first virtual machine from a first backup of the infected device. First file reputation data for a plurality of files of the first virtual machine is received. The first file reputation data is stored onto a disk drive accessible by the first virtual machine. Upon detection of malware on the first virtual machine from a first malware scan performed using the first file reputation data, a second virtual machine is created from a second backup of the infected device. A second malware scan of the second virtual machine is performed using the first file reputation data from the secondary storage disk drive. Upon detection of no malware on the second virtual machine, the second backup of the infected device is used as a recovery image to restore the infected device.

### RELATED APPLICATIONS

Benefit is claimed under 35 U.S.C. 119(a)-(d) to Foreign Application Serial No. 202341049836 filed in India entitled “RAPID MALWARE SCANNING USING VALIDATED REPUTATION CACHE”, on Jul. 24, 2023, by VMware, Inc., which is herein incorporated in its entirety by reference for all purposes.

### BACKGROUND

In computer system management, disaster recovery includes techniques to protect against events that can negatively impact the integrity of a system and its underlying computing devices (e.g., servers, virtual machines, or the like). Typical goals of disaster recovery are to minimize downtime, mitigate data loss, and ensure business continuity in the face of unexpected incidents such as natural disasters, cyberattacks, hardware failures, or human errors. Preparation efforts sometimes include a backup and recovery plan that establishes regular, automated backup processes to create backup copies of the protected computing devices, such as copies of critical data, applications, system configurations, or the like. These backups can be stored onsite (e.g., for quick, on-premise access) or offsite (e.g., for protection against physically impacting events at the premises of the protected devices, such as with natural disasters). In the event of a disruptive event, recovery mechanisms can be used to restore operation of the computing devices using the backups.

A malware infection event is one type of disruptive event that can impact the operation of some computing systems. Malware, short for malicious software, refers to software or code designed to disrupt, damage, or gain unauthorized access to computer systems, networks, or user devices. Malware can include, for example, viruses, worms, Trojan horses, ransomware, spyware, adware, and many more. The primary intent behind malware is often malicious, such as stealing sensitive information, causing system malfunctions, or gaining control over compromised devices.

Ransomware is one type of malware that typically involves the encryption of files and/or locking down of an entire computing device, rendering the device inaccessible to users. Attackers demand a ransom in exchange for restoring access or decrypting the files. Ransomware attacks can have severe consequences, including data loss, financial losses, and operational disruptions.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Aspects of the disclosure analyze backups of a primary computing instance for malware and restore the primary computing instance using a validated reputation cache. Solutions include: creating a first virtual computing instance from a first backup of the primary computing instance; receiving, from a secondary computing device, first file reputation data for a plurality of files of the first virtual computing instance; storing the first file reputation data onto a secondary storage disk drive accessible by the first virtual computing instance; upon detection of malware on the first virtual computing instance from a first malware scan performed using the first file reputation data, creating a second virtual computing instance from a second backup of the primary computing instance; performing a second malware scan of the second virtual computing instance using the first file reputation data from the secondary storage disk drive; and upon detection of no malware on the second virtual computing instance, causing the second backup of the primary computing instance to be used as a recovery image to restore the primary computing instance.

### BRIEF DESCRIPTION OF THE DRAWINGS

The present description will be better understood from the following detailed description read in the light of the accompanying drawings, wherein:

FIG. 1 illustrates an example architecture that advantageously provides recovery techniques and methods for recovering and restoring computing services in response to disruptive events such as ransomware attacks;

FIG. 2A and FIG. 2B are sequence diagrams that illustrate an example process for performing malware scanning on backups of a protected device using an example architecture, such as that of FIG. 1;

FIG. 3 is a flow chart of exemplary operations associated with restoring a computing device using a reputation cache in an example architecture, such as that of FIG. 1;

FIG. 4 illustrates a virtualization architecture that may be used as a version of computing platform; and

FIG. 5 illustrates a block diagram of an example computing apparatus that may be used as a component of example architectures, such as those of FIG. 1 and FIG. 6.

Any of the figures may be combined into a single example or embodiment.

### DETAILED DESCRIPTION

Aspects of the disclosure provide disaster recovery techniques for improving remediation of certain types of disruptive events affecting computing devices. In examples, a recovery system captures copies of data (e.g., snapshots, backups) of an underlying computing device (the “protected device” in these examples), such as a server system, a virtual machine, or the like. These snapshots may be captured periodically from the protected device (e.g., as hourly snapshots, daily snapshots) and are stored at an intermediary location, such as a cloud disaster recovery (DR) site or any storage system external to the protected device. Multiple snapshots are stored and maintained at the storage site at any particular point in time, and may be used in response to disruptive events affecting the protected device, such as to recover data from, or otherwise restore the protected device, whether on the same physical hardware device or a different recovery device.

If the protected device experiences a malware attack such as a ransomware attack, the protected device experiences some exposure in which recovery operations are desired. The protected device may be inaccessible to users, and thus a full backup recovery and restore of the protected device may be desired. In such situations, the recovery system described herein uses the snapshots stored at the storage site to assist in the recovery. However, it may be possible that one or more of the snapshots already had the malware at the time the snapshot was made. As such, recovery using that particular snapshot may lead to a recovered system that is still infected with the malware.

Aspects of the disclosure provide a computationally efficient system and method to identify which of the backup copies of the protected device are infected, and which are not infected by the malware. In this manner, the most recent uninfected backup copy is identified and used to restore the operation of the protected device. In an example, the recovery system includes a recovery site that is used to evaluate and validate the various backup copies stored at the storage site to determine the most recently made backup copy that is not infected by the malware. More specifically, in some examples, the recovery site includes a virtualization environment in which a test virtual machine (VM) is instantiated by a recovery agent. The recovery agent installs a malware agent onto the test VM. The recovery agent also initially copies the most recent backup instance or image of the protected device to storage on the test VM for inspection. In some examples, the test VM may boot from the backup image, while in other examples the test VM may be installed with its own operating system and the backup image may be restored onto other storage on the test VM.

Once the initial backup is loaded, the malware agent scans the files of this particular backup instance looking for signatures of malware. The malware agent will download reputation data for each of the files from a reputation database. For this initial backup instance, file reputations are downloaded for all of the files occurring in this particular backup. Depending on the number of files, this reputation data can range from a few kilobytes (KB) to several gigabytes (GB) or more.

If no malware is detected during the scanning of the first backup instance, then that first backup instance is identified by the recovery agent as a good recovery image to use for restoring the protected VM. As such, the first image may then be used to rebuild or restore the protected VM (e.g., at the protected site or at some other DR site). However, in situations where the first backup instance is found to be infected, then the recovery agent may terminate the test VM and move onto the next most recent backup instance, and may likewise construct a new instance of the test VM, load the next backup instance, reinstall the malware agent, and perform a malware scan on the next backup instance.

The download of reputation data during the creation of these test VMs creates a network traffic and computational burden on both the test VM infrastructure, the reputation database, and on the network infrastructure connecting these two systems. As such, during the initial download of reputation data for the first backup instance, the recovery agent creates a reputation cache at the recovery site and stores the reputation data within that reputation cache. During each subsequent validation of each of the backup instances, the test VM uses the reputation cache (e.g., as a locally-mounted drive or the like) for any files that overlap between the first backup instance and subsequent backup instances. Since most files in one backup instance of the same computing device typically are present in other backup instances, most of the reputation data needed during a malware scan of subsequent backup instances will be available in the reputation cache, and thus will not need to be reacquired from the reputation database.

Aspects of the disclosure improve the operations of a computer by reducing the amount of network traffic and computational burden with duplicate copying of reputation data during multiple malware scans of backup images from a given computing device. In situations where multiple backup images of the same computing device need to be scanned, and reputation data needs to be acquired and used during each of those malware scans, the architecture and methods described herein reduce the redundant requests for reputation data after initial acquisition. The local storage and retention of such reputation data between scanning of multiple backup instances allows the reputation data for particular files to be requested and acquired only once, thereafter retaining the reputation data locally such that most or all of the reputation data needed for a scan of another backup instance is already locally present.

While described with reference to VMs in various examples, the disclosure is operable with any form of virtual computing instance (VCI) including, but not limited to, virtual machines (VMs), containers, or other types of isolated software entities that can run on a computer system. Alternatively, or additionally, the architecture is generally operable in non-virtualized implementations and/or environments without departing from the description herein.

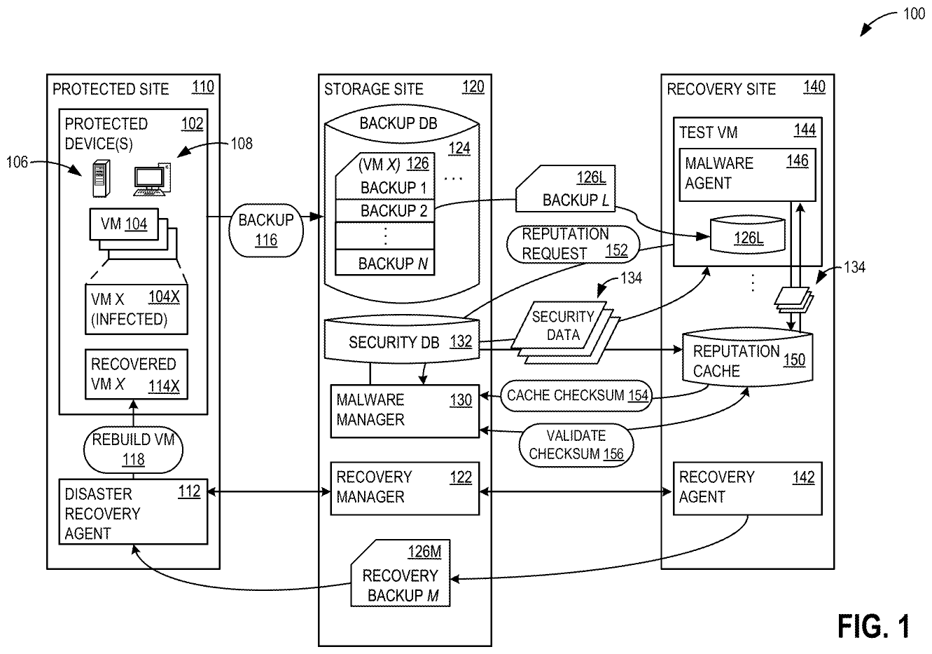

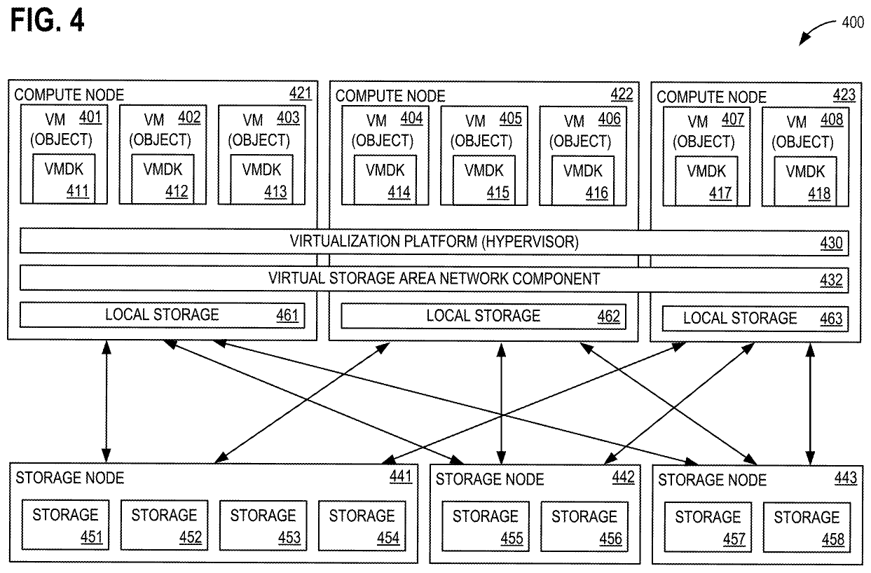

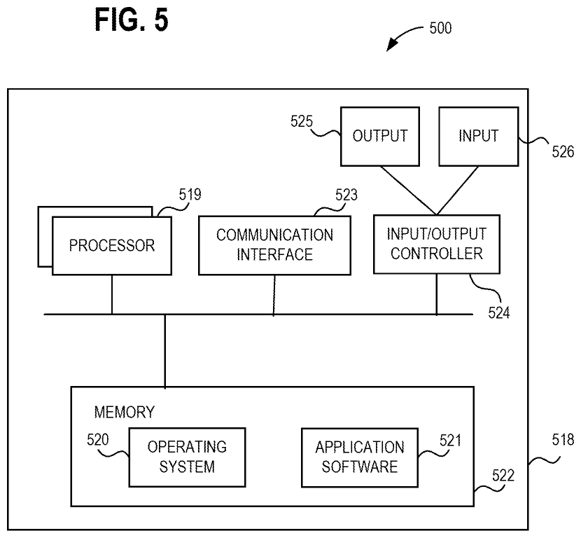

FIG. 1 illustrates an example architecture 100 that advantageously provides recovery techniques and methods for recovering and restoring computing services in response to disruptive events such as ransomware attacks. Architecture 100 uses a computing platform which may be implemented on one or more computing apparatus 518 of FIG. 5 and/or using a virtualization architecture 400 as illustrated in FIG. 4. In this example, the architecture 100 includes a protected site 110, a storage site 120, and a recovery site 140, any or all of which may use a virtualization architecture such as the virtualization architecture 400 of FIG. 4. For purposes of illustration and discussion, the protected site 110 executes one or more protected computing resources (or just “protected devices”) 102, such as a production enterprise datacenter environment or the like, and these protected devices 102 contain data that is the subject of the backup and recovery techniques described herein. The storage site 120 represents a backup environment in which backups of the protected devices 102 are stored. The recovery site 140 represents a recovery environment in which particular malware detection operations are performed during recovery operations after one of the protected devices 102 has become infected by malware, as described herein.

At the protected site 110, the protected devices 102 include one or more virtual machines 104, server devices 106, or other computing devices 108 such as desktop computing devices, laptops, infrastructure hardware, or the like. These protected devices 102 may be referred to herein as computing instances, and may be VCIs (e.g., VMs, containers, or the like) or physical computing instances (e.g., server computing devices, desktop computing devices, or the like). Each of these protected devices 102 includes persistent storage (e.g., disk storage provided by local storage devices, storage area network (SAN) storage devices, cloud storage, network-attached storage, or the like), and this persistent storage (not separately shown) is subject to occasional backup 116 operations. These backup 116 operations include copying some or all of the persistent storage of the protected devices 102 to the storage site 120.

The storage site 120 includes a repository for the backup 116 operations, represented here as backup DB 124, in which the backups of the protected devices 102 are stored. The backup DB 124 can include any persistent storage solutions known in the art, such as hard disk drives, solid state drives, SAN storage, magnetic tape storage, network-attached storage (NAS), cloud storage, or the like. The architecture may include backup solutions such as commercially available backup and recovery software systems, or bespoke data copy operations sufficient to enable the systems and methods described herein. Further, backup 116 operations can include any type of data copy operations (e.g., full backups, incremental backups, differential backups, synthetic full backups, copy backups, continuous data protection, snapshots, data synchronization, data replication, changed block tracking, or the like) and these backup 116 operations are occasionally performed on the protected devices 102 such as to generate several backups of the protected device 102. As such, various instances or versions of these backups can be restored, with each backup having a different time of the backup (e.g., a time at which the backup was made), thus allowing file-level recovery of the protected device 102 and its associated persistent storage from the various times. In these examples, it is presumed that a backup system (not separately shown) orchestrates and manages backup 116 operations for the protected devices 102, and that these backup 116 operations are consistent with creating and maintaining the backup DB 124 as shown and described herein.

For purposes of these examples, a particular protected device 102, a “VM X” 104X, is the subject of backup 116 operations during its operational lifecycle, and this VM X 104X is presumed to have become infected by ransomware at some point. Upon recognition of the infection of VM X 104X, a malware analysis and recovery operation is initiated. At this time, the backup DB 124 includes a set of backups 126 for VM X 104X, labeled in FIG. 1 as “Backup 1”, “Backup 2”, . . . , “Backup N”, ordered by backup time (e.g., when the backup was taken), and where “Backup 1” is the most recently-made backup of VM X 104X, and where “Backup N” is the oldest backup of VM X 104X. These backups 126 are presumed to allow restoration of the persistent storage of VM X 104X, whether back to the original VM X 104X at the protected site 110 or, as in the example described below, to another VM such as a test VM 144 at the recovery site 140.

The recovery site 140, in this example, includes a recovery agent 142 that is configured to perform various malware analysis operations of the backups 126 of VM X 104X during this recovery process. During this example recovery process, the recovery agent 142 analyzes the backups 126 of VM X 104X in search for the most recently made backup 126 that is “clean” (e.g., not infected by malware). This recovery process starts with analyzing the most recent backup 126, namely “Backup 1”, analyzing the files from that backup to determine whether or not the malware is present in that version of the backup 126. If that version is found to be clean, then that version is identified for use during recovery and rebuilding of the VM X 104X. If, on the other hand, that version is found to be infected (e.g., to include the malware), then the recovery agent 142 moves onto the next version of the backup 126 (e.g., the next most recent version) and inspects that version for the malware. This process continues until a “clean” version of the backup 126 is found. This analysis process is described in greater detail below.

More specifically, upon initiation of a recovery process for VM X 104X, the recovery agent 142 instantiates a new virtual machine, test VM 144, at the recovery site 140. In some examples, the test VM 144 is built from the backup 126 as a replicated copy of VM X 104X (e.g., booting from a copy of a boot drive of VM X 104X recovered from the backup(s) 126, along with any other persistent data and/or drives of VM X 104X), and as such, may execute the same operating system and applications as configured for VM X 104X. These examples are referred to herein as “replication testing,” inasmuch as the test VM 144 is a replicated copy of VM X 104X. In other examples, the test VM 144 is built with its own operating system (e.g., independent of the backups 126 of VM X 104X). These examples are referred to herein as “independent copy testing,” as the test VM 144 receives a copy of the backup 126 but independently provides the underlying OS executed by the test VM 144. In either case, one of the versions of the backup 126 of VM X 104 is copied to persistent storage allocated to the test VM 144, represented in FIG. 1 as “Backup L” 126L. In either instance, a hash of the file may be used, such as a sha256 or md5 of the file. Initially, “Backup 1” of the backups 126 (e.g., the most recent of the backups 126) is copied to the test VM 144 for malware inspection. This data copy of “Backup L” 126L to the test VM 144 can be any type of data copy sufficient to enable the systems and methods described herein. Accordingly, the files of “Backup L” 126L are copied to, and present on, the test VM 144 for malware analysis.

Additionally, a malware agent 146 is installed on the test VM 144. The malware agent 146 is a software component configured to perform malware analysis on files local to the test VM 144 and, more particularly, to the files of “Backup L” 126L. The malware agent 146 may be, for example, an endpoint of a malware prevention system that includes a malware manager 130 running at a secondary site, such as the storage site 120, as a cloud service, or the like. In some examples, the recovery agent 142 causes the malware agent 146 to be installed on the test VM 144. In other examples, the malware agent 146 may come already installed on the test VM 144. For example, in replication testing examples, the malware agent 146 is already installed on VM X 104X, while in independent copy testing examples, the malware agent 146 is already installed on a golden image used to build the test VM 144 and associated operating system. In some examples, the malware agent 146 may be installed on its own virtual disk drive (not shown) and may be provisioned or mounted to the test VM 144 for installation or execution.

The malware agent 146 is configured to perform file scanning of the files of the test VM 144 using security data 134 provided by the malware manager 130. In the example, the malware agent 146 transmits reputation request(s) 152 to the malware manager 130 requesting security data associated with the particular files that appear on the backup 126L. The reputation request 152 may, for example, include a file path of each of the files appearing on the backup 126L. The malware manager 130 has security data for files already stored in the security DB 132 and provides this security data 134 for each of the files in response to the request 152. This security data 134 includes, for example, a checksum or hash value associated with the particular file, representing a value that is expected to match the file as it appears on the backup 126L if that file is not corrupted (e.g., modified to contain a virus). For example, a hash is calculated using sha256 or md5. Any or all of the files of the backup 126L may have some security data 134 associated with that file. The malware manager 130 may look up the security data 134 for a given file from the security DB 132 based on, for example, an absolute path, a relative path, an application (e.g., based on application identifier, version, and the like), an operating system (e.g., OS version, patch level, and the like), a checksum value (e.g., created from the file as it appears on the backup 126L). Given that there can be many thousands files or more appearing on any given protected device 102, the security data 134 for all of the files of the backup 126L can range in the kilobytes to the gigabytes of security data 134.

The malware agent 146 uses this security data 134 while scanning the files of the backup 126L. For example, the malware agent 146 may receive a checksum of a given file (the “expected checksum”) from the malware manager 130 and may compare the expected checksum to a checksum made from the file as it appears on the backup 126L (the “actual checksum”). In the case where the actual checksum does not match the expected checksum, the malware agent 146 may identify this file as potentially containing malware. If malware is identified, then this particular backup 126 may be identified as corrupt and thus the recovery manager 122 may move onto the next backup 126 and continue to look for an uninfected backup 126. In some examples, the malware agent 146 issues an alert with the file name, hash value (e.g., sha256 hash) and prompts for deeper inspection. The malware agent 146 may also upload the suspicious file to the malware manager 130 for further analysis. The further analysis may be done by a threat research team (e.g., in an asynchronous manner at the malware manager 130).

In this example, presume that “Backup 1” 126 has been identified as corrupt (e.g., as containing malware) during the initial build of test VM 144. If the recovery agent 142 simply moves onto the next backup 126, rebuilds the test VM 144 with the next backup 126, and performs the request 152 as described above, then all of the security data 134 would have to be re-requested and re-transmitted again from the malware manager 130.

The recovery site 140 includes a reputation cache 150 in which security data 134 can be stored and persisted across multiple builds of the test VM 144. In the example, the recovery agent 142 creates the reputation cache 150 as persistent storage (e.g., a virtual disk or the like) and provisions the reputation cache to the test VM 144. During analysis of the first backup 126, when the test VM 144 initially receives the security data 134 from the malware manager 130, the test VM 144 stores the security data 134 in the reputation cache 150 (e.g., as a record or entry for each file, including file path plus any fields for the security data 134 for that file). As such, the original security data 134 is stored and can be used in analysis of subsequent backups.

During a subsequent analysis of another backup 126 (e.g., when inspecting “Backup 2” through “Backup N”), the reputation cache 150 is first consulted for the security data 134 of a given file. More specifically, for each file appearing on the backup 126L, the malware agent 146 first looks to see whether or not there is security data 134 for that file in the reputation cache 150 (e.g., as a “local query”). If the given file has security data 134 stored on the reputation cache 150 (e.g., in situations where the file appeared in an already-inspected backup), then the security data 134 from the reputation cache 150 is used for that file. If there is no security data 134 for the file currently present in the reputation cache 150 (e.g., in situations where the file did not appear in an already-inspected backup 126), then the malware agent 146 sends a reputation request 152 to the malware manager 130 to retrieve the security data 134 for that file. In the example, the reputation cache 150 is locally mounted to the test VM 144 and, as such, the malware agent 146 can directly access the reputation cache 150. In other examples, the recovery agent 142 may manage the reputation cache 150 and, as such, may receive queries for security data 134 from the malware agent 146 and perform any other management functions consistent with the systems and methods described herein.

In some examples, the reputation cache 150 may be inspected before it is used as the source of security data 134. For example, after the reputation cache 150 is initially created, a “cache checksum” 154 of the complete reputation cache 150 may be computed (e.g., by the test VM 144 after all of the initial security data 134 for the files of “Backup 1” is stored on the reputation cache 150). This cache checksum 154 may be transmitted to the malware manager 130 and stored for later use. When a subsequent backup 126 is being analyzed by a new build of the test VM 144, and before the reputation cache 150 is used, the malware agent 146 may recompute the cache checksum 154 of the reputation cache 150 and send that cache checksum 154 to the malware manager 130 to validate the checksum at 156. If the original cache checksum 154 matches the current checksum, then the malware manager 130 confirms and approves the use of the reputation cache 150 for analyzing this current backup 126L. If the checksums do not match, then the malware agent 146 does not use the reputation cache 150 and instead sends new reputation requests 152 to the malware manager 130. As such, the malware agent 146 can protect from corruption of the reputation cache 150 (e.g., by infection from other malware).

In some examples, the reputation cache 150 may be updated during analysis of subsequent backups 126. For example, if security data 134 for some files are not found within the reputation cache 150 during analysis of a given backup 126L, then additional reputation requests 152 are formed to retrieve the security data 134 for those “new” files from the malware manager 130, as discussed above. This new security data 134 may then be added to the reputation cache 150 for use in still later backups 126, thus updating the reputation cache 150 with files that may also appear in subsequent backups 126. If such updates to the reputation cache 150 are made, then a new cache checksum 154 may be computed and sent to the malware manager 130 for use in subsequent checksum validations at 156.

Accordingly, in the example, the recovery agent 142 causes the test VM 144 to be rebuilt for each analysis of one of the backups 126. Once a “clean” backup 126 is identified, that version of the backup 126 is identified by the recovery agent 142 as the backup (e.g., “Backup M” 126M) to use to rebuild the protected device 102 (e.g., to rebuild VM X 104X). The recovery agent 142 communicates with the recovery manager 122 to identify “Backup M” 126M as the particular backup 126 to use for recovery. The recovery manager 122 communicates with a disaster recovery agent 112 at the protected site 110 to initiate the recovery. The disaster recovery agent 112 then uses “Backup M” 126M to rebuild/restore VM at 118, thereby creating a recovered VM X 114X as shown in FIG. 1.

While the malware testing platform is shown as a virtual machine, namely test VM 144, it should be understood that other computing platforms may be used in lieu of the test VM 144. In some examples, a stand-alone computing device such as a server or desktop computing device or a cloud computing device may be used in lieu of the test VM 144.

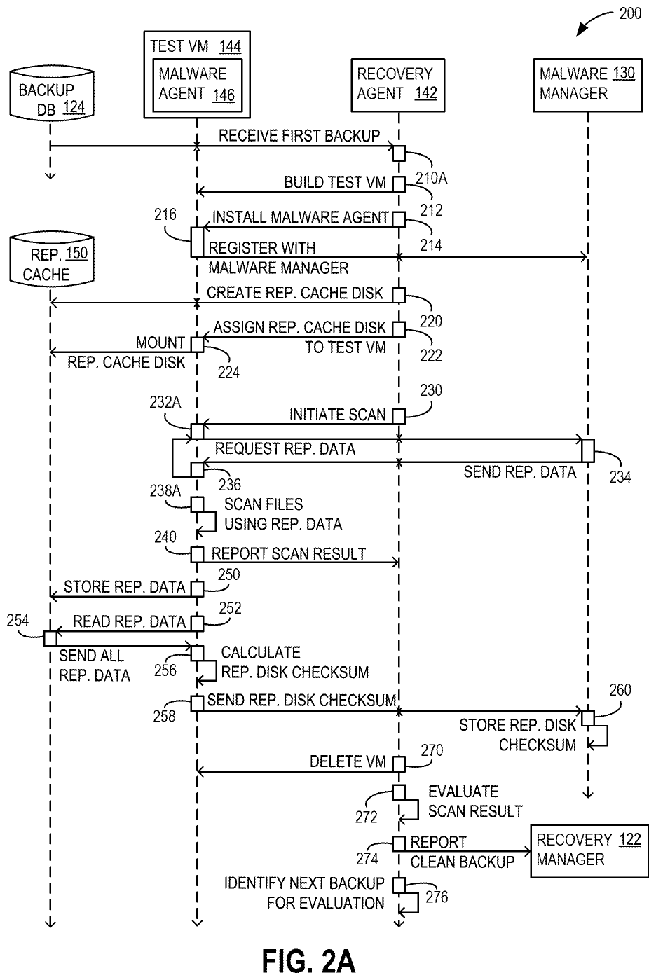

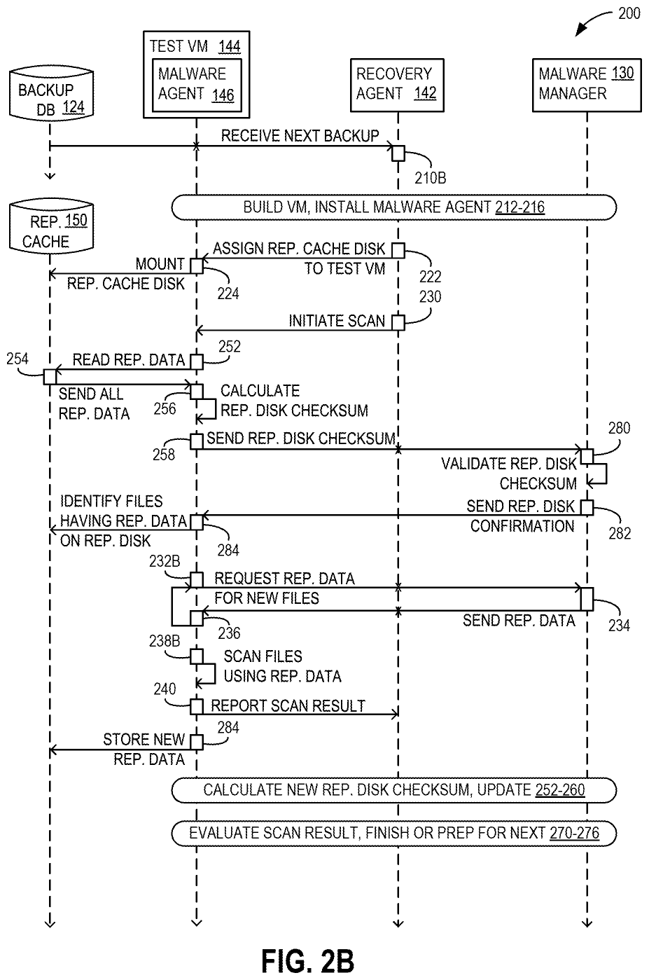

FIG. 2A and FIG. 2B are sequence diagrams that illustrate an example process 200 for performing malware scanning on backups 126 of a protected device 102 using the architecture 100 of FIG. 1. In this example, VM X 104X is used as the example protected device 102, and it is presumed that there are multiple backups 126 of the protected device 102 (e.g., VM X 104X) existing and available from the backup DB 124 and that each particular backup 126 has a backup date/time associated with when that backup 126 was taken. FIG. 2A illustrates steps performed during malware analysis of the first backup 126 (e.g., “Backup 1”, the most recent backup of VM X 104X), and FIG. 2B illustrates differences in steps performed during analysis of each subsequent backup 126 (e.g., “Backup 2” through “Backup N”, or until a “clean” backup is identified).

Referring now to FIG. 2A, the recovery agent 142 receives the first backup 126 (e.g., “Backup 1”) from the backup DB 124 at 210A. At 212, the recovery agent 142 builds the test VM 144. In some examples, the virtual disk drive(s) used to build the test VM 144 may be built as replicated copies or clones of the virtual disk drive(s) of VM X 104 (e.g., with data sourced from the “Backup 1” backup 126), and thus the test VM 144 may be booted from the replicated boot drive. In other examples, the test VM 144 may be built with a fresh image of an operating system (e.g., on a boot drive independent of the backup 126), and the files from the backup 126 may be restored onto additional virtual disk drives assigned to the test VM 144. At 214, the recovery agent 214 causes the malware agent 146 to be installed on the test VM 144. At 216, the malware agent 146 registers itself with the malware manager 130.

At 220, the recovery agent 142 creates the reputation cache 150 that will be used throughout this malware analysis process 200. It is presumed, for purposes of this example, that the reputation cache 150 is created as a virtual disk drive of a sufficient size to hold any and all security data 134 as needed. At 222, the recovery agent 142 assigns the reputation cache 150 disk to the test VM 144 and the test VM mounts the reputation cache 150 disk at 224. Further, in this example, the security data 134 used to perform the malware analysis of the backups 126 is referred to in FIG. 2A and FIG. 2B as “reputation data” or “rep. data,” and can include any security data that may be used to evaluate the files of backups 126 (e.g., file checksums, file reputations, policy settings, virus signatures, or the like).

At this stage in the process 200, the test VM 144 has the files of the first backup 126, “Backup 1”, and is prepared to perform a malware scan of those files. At 230, the recovery agent 142 initiates the malware scan on the test VM 144. This malware scan is being performed by the malware agent 146 in this example. At 232A, the malware agent 146 begins this first malware scan by identifying the files to be scanned and requesting reputation data (e.g., security data 134) from the malware manager 130. For the analysis of this first backup 126, the malware agent 146 may request reputation data for all of the files of the backup 126, or some subset of those files (e.g., all files not expressly excluded by a security policy). In this example, the reputation data for each file includes an expected checksum of that file. At 234, the malware manager 130 sends the reputation data to the malware agent 146 in response to the request. The malware agent 146 may send one or more bulk requests for file reputation data (e.g., requests that identify numerous files at one time) or individual requests for reputation data (e.g., a request for each file) at 236.

At 238A, the malware agent 146 uses the reputation data received from the malware manager 130 to perform the malware scan of the files of this first backup 126, “Backup 1”. This malware scanning can include, for example, creating a checksum of a particular file and comparing that checksum to an expected checksum for that particular file. In some examples, the malware scanning determines, based on individual file scans, whether the given backup image is clean or not using the full file hash (e.g., based on sha256, md5, or the like) or the particular chunk-based hash method (e.g., first 4 k bytes, random 4 k bytes, or last 4 k bytes of hash). At 240, the malware agent 240 makes a determination as to whether this current backup 126 is “clean” or not (e.g., uninfected by malware) and reports this scan result to the recovery agent 142.

At 250, the malware agent 146 stores the reputation data onto the reputation cache 150. The reputation data stored on the reputation cache 150 may be used in subsequent malware scans of other backups 126. To protect the integrity of the data on the reputation cache 150, the malware agent 146 creates a checksum of the reputation cache 150 after all of the reputation data has been written to the disk and sends that “reputation disk checksum” to the malware manager 130 for later use. More specifically, at 252, the malware agent 146 reads all of the reputation data sent from the reputation cache at 254. At 256, the malware agent 146 calculates the reputation disk checksum over all of the reputation data stored on the reputation cache 150. At 258, the malware agent 146 sends the reputation disk checksum to the malware manager 130 and the malware manager 130 stores that reputation disk checksum at 260. The reputation disk checksum will be used to verify the integrity of the reputation cache 150 before its next use, as discussed below in reference to FIG. 2B.

Returning again to the operations of the recovery agent 142, the recovery agent 142 performs some cleanup operations after the malware scanning operations have completed for this current backup 126, including deleting test VM 144 at 270. Further, having received the scan result for this first backup 126 from the malware agent 146, the recovery agent 142 now evaluates the scan result and determines whether a clean backup has been found in this current backup 126 or whether this current backup 126 is infected with malware, and thus further backups 126 should be investigated. More specifically, if the current backup 126 is determined to be a “clean” backup 126, then the recovery agent 142 sends a message to the recovery manager 122, at 274, reporting this current backup 126 (e.g., “Backup 1”) as clean, thus identifying this current backup 126 as the backup 126 to use to rebuild/restore VM X 114X. If the current backup 126 is not clean, then the recovery agent 142 identifies the next backup 126 for evaluation at 276 (e.g., the next-older backup 126 from the current backup, in this case “Backup 2”), and the process 200 continues into FIG. 2B.

Referring now to FIG. 2B, the steps shown here are performed for each subsequent backup 126 that is analyzed by the recovery agent 142 (e.g., until a “clean” backup 126 is found). It should be noted that some steps are summarized in bubbles here for purposes of brevity, and that those steps are similar to those performed in the analysis of the first backup 126 as shown and described in FIG. 2A.

At 210B, the recovery agent 142 receives the next backup from the backup DB 124 (e.g., as identified at 276 of FIG. 2A). This next backup 126 is used to build the test VM 144 and install the malware agent 146, as in 212-216. As such, the test VM 144 then has the files from that next backup 126. At 222, since the reputation cache 150 was already created during analysis of the first backup 126, the recovery agent 142 just assigns the reputation cache 150 disk and the test VM 144 mounts the reputation cache 150 disk at 224.

At 230, the recovery agent 142 initiates this next malware scan. However, during these subsequent malware scans of other backups 126, the malware agent 146 now may use reputation data from the reputation cache 150. Before using the reputation data from the reputation cache 150, however, the malware agent 146 first evaluates the integrity of the reputation cache 150 (e.g., to ensure that no changes have been made to the reputation cache 150, such as by other malware). More specifically, the malware agent 146 calculates a reputation disk checksum at operations 252-256 and sends that reputation disk checksum to the malware manager 130 at 258. At 280, the malware manager 130 validates this reputation disk checksum against the prior reputation disk checksum previously received from the malware agent 146 (e.g., stored at 260 of FIG. 2A, or having been updated later at 260 here in FIG. 2B). This validation includes comparing the current reputation disk checksum against the prior reputation disk checksum to determine whether or not they are identical. At 282, the malware manager 130 sends a confirmation of the reputation disk checksum to the malware agent 146 (or a rejection if the checksums do not match).

As such, this checksum confirmation determines whether or not the malware agent 146 uses reputation data from the reputation cache 150 during subsequent operations. In cases where the reputation cache 150 was not confirmed for use, the malware agent 146 deletes all of the reputation data from the reputation cache 150 (not shown) and rebuilds the reputation cache 150, requesting all of the reputation data for the files of this current backup 126 from the malware manager 130, storing that reputation data on the reputation cache 150, and recreating a new checksum for the reputation cache 150, as in 232A-260 of FIG. 2A.

In situations where use of the reputation cache 150 is confirmed, the malware agent 146 proceeds with the malware scanning of this current backup 126 using reputation data from the reputation cache 150. However, some of the files of this current backup 126 may not have reputation data already stored on the reputation cache 150 (e.g., files that exist in the current backup but did not exist in any of the previously-scanned backups 126). As such, since reputation data for these “new” files does not exist on the reputation cache 150, that reputation data will be acquired from the malware manager 130. More specifically, at 284, the malware agent 146 compares the files of the current backup 126 to the reputation data present in the reputation cache 150 to identify which files have reputation data already present on the disk and which files do not. The malware agent 146 then requests reputation data from the malware manager 130 for each of these new files at 232B (e.g., similar to 232A, but for only the new files). As such, once all of the reputation data for the current backup 126 is acquired, either from the reputation cache 150 or from the request(s) at 232B, the malware agent 146 performs a scan of the files at 238B, using the reputation data from the reputation cache 150 and possibly as acquired from the additional requests at 232B. Similarly, the malware agent 146 reports the scan results for this current backup to the recovery agent 142 at 240.

In situations where there were some new files, and additional reputation data was acquired from the malware manager 130 at 232B, the malware agent 146 updates the reputation cache 150 by storing this new reputation data on the reputation cache 150 disk at 284. Because the contents of this reputation cache 150 have thus changed, a new reputation disk checksum is calculated and sent to the malware manager 130 (e.g., similar to steps 252-260, where the storing of the reputation disk checksum at 260 overwrites the prior reputation disk checksum).

Similar to the first backup analysis of FIG. 2A, the recovery agent 142 evaluates the scan results and determines whether to finish this process 200 (e.g., if a clean backup has been found, or if the last backup has been examined) or continue onto the next backup, such as in 270-276.

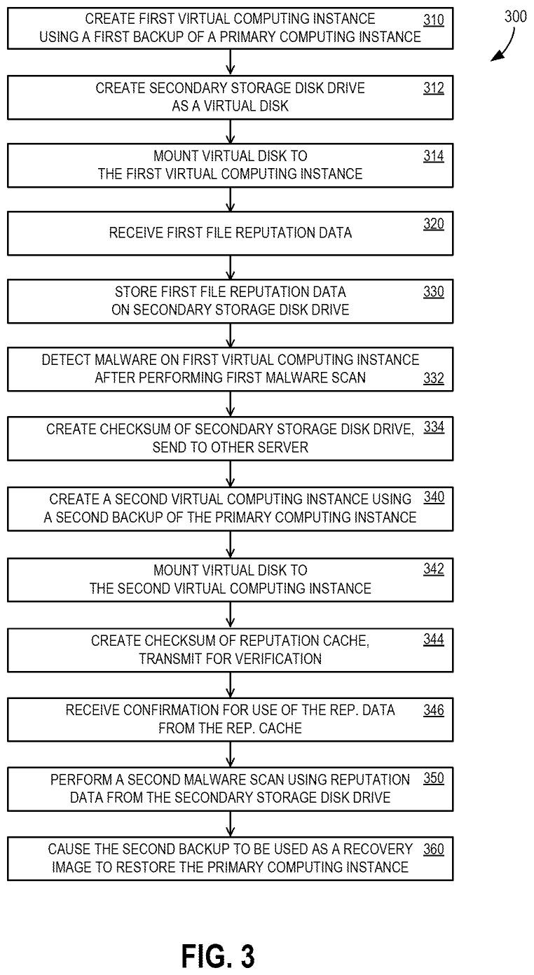

FIG. 3 is a flow chart 300 of exemplary operations associated with restoring a computing device using a reputation cache in the architecture 100 of FIG. 1. In this example, the recovery agent 142 of FIG. 1 creates test VMs 144 to perform malware scans of the various backups 126 of a protected device 102 such as VM X 104X after a malware infection, such as a ransomware-based shutdown. In the example, the recovery agent 142 creates a first virtual computing instance (e.g., a first instance of the test VM 144) from a first backup of a primary computing instance (e.g., VM X 104X) at operation 310. In some examples, the recovery agent 142 also causes a malware agent 146 (e.g., an endpoint of a malware system) to be installed on the first virtual computing instance.

At operation 320, the first virtual computing instance (e.g., the malware agent 146 of the test VM 144) receives, from a secondary computing device (e.g., the malware manager 130), first file reputation data (e.g., security data 134) for a plurality of files of the first virtual computing instance (e.g., files restored from a backup 126 of VM X 104X). At operation 330, the first virtual computing instance stores the first file reputation data onto a secondary storage disk drive accessible by the first virtual computing instance (e.g., reputation cache 150). Upon detection of malware on the first virtual computing instance from a first malware scan performed using the first file reputation data at operation 332, the recovery agent 142 creates a second virtual computing instance at operation 340 (e.g., a second instance of the test VM 144) from a second backup of the primary computing instance. In some examples, the malware agent 146 is reinstalled on the second virtual computing instance. At operation 350, the second virtual computing instance performs a second malware scan of the second virtual computing instance using the first file reputation data from the secondary storage disk drive. At operation 360, upon detection of no malware on the second virtual computing instance, the recovery agent 142 causes the second backup of the primary computing instance to be used as a recovery image to restore the primary computing instance (e.g., to rebuild VM X 104X, as in operation 118).

In some examples, the malware agent 146 creates a first checksum based on contents of the secondary storage disk drive at a first time (e.g., after storing the first file reputation data to the reputation cache 150) and transmits the first checksum to another computing device at operation 334 (e.g., to malware manager 130). The malware agent 146 also creates a second checksum based on contents of the secondary storage disk drive at a second time, such as after mounting the reputation cache 150 during a subsequent backup analysis, and before using the reputation data stored on the reputation cache 150. The malware agent 146 transmits the second checksum to the other computing device at operation 344 for comparison and verification that no changes have been made to the reputation cache 150. The malware agent 146 receives a confirmation from the other computing device that the second checksum matches the first checksum. The malware agent thus uses the first file reputation data from the secondary storage disk drive contingent upon the receiving of the confirmation at 346.

In some examples, the recovery agent 142 creates the secondary storage disk drive as a virtual disk drive at operation 312 (e.g., during analysis of the first backup), and the secondary storage disk drive is mounted to the first virtual computing instance at operation 314 (e.g., during the first backup analysis) and to the second virtual computing instance at operation 342 (e.g., during the second backup analysis).

In some examples, one or more of the first malware scan and the second malware scan includes a file-based checksum comparison that includes at least creating a file checksum of a first file and comparing the file checksum with an expected checksum associated with the first file identified by the first file reputation data.

In some examples, the second backup of the primary computing instance includes one or more files not present in the first backup of the primary computing instance, and the malware agent 146 receives, from the secondary computing device, second file reputation data for the one or more files, wherein performing the second malware scan of the second virtual computing instance further uses both the second file reputation data received from the secondary computing device and the first file reputation data from the secondary storage disk drive. In some examples, the malware agent 146 stores the second file reputation data on the secondary storage disk drive along with the first file reputation data. In some examples, the malware agent 146 creates a third checksum based on contents of the secondary storage disk drive after storing the second file reputation data on the secondary storage disk drive and transmits the third checksum to another computing device for use validating use of the secondary storage disk drive during a subsequent malware scan of another backup of the primary computing instance.

Examples of architecture 100 are operable with virtualized and non-virtualized solutions. FIG. 4 illustrates a virtualization architecture 400 that may be used as a version of computing platform. Virtualization architecture 400 is comprised of a set of compute nodes 421-423, interconnected with each other and a set of storage nodes 441-443 according to an embodiment. In other examples, a different number of compute nodes and storage nodes may be used. Each compute node hosts multiple objects, which may be virtual machines (VMs, such as base objects, linked clones, and independent clones), containers, applications, or any compute entity (e.g., computing instance or virtualized computing instance) that consumes storage. When objects are created, they may be designated as global or local, and the designation is stored in an attribute. For example, compute node 421 hosts objects 401, 402, and 403; compute node 422 hosts objects 404, 405, and 406; and compute node 423 hosts objects 407 and 408. Some of objects 401-408 may be local objects. In some examples, a single compute node may host 50, 100, or a different number of objects. Each object uses a VM disk (VMDK), for example VMDKs 411-418 for each of objects 401-408, respectively. Other implementations using different formats are also possible. A virtualization platform 430, which includes hypervisor functionality at one or more of compute nodes 421, 422, and 423, manages objects 401-408. In some examples, various components of virtualization architecture 400, for example compute nodes 421, 422, and 423, and storage nodes 441, 442, and 443 are implemented using one or more computing apparatus such as computing apparatus 518 of FIG. 5.

Virtualization software that provides software-defined storage (SDS), by pooling storage nodes across a cluster, creates a distributed, shared data store, for example a storage area network (SAN). Thus, objects 401-408 may be virtual SAN (vSAN) objects. In some distributed arrangements, servers are distinguished as compute nodes (e.g., compute nodes 421, 422, and 423) and storage nodes (e.g., storage nodes 441, 442, and 443). Although a storage node may attach a large number of storage devices (e.g., flash, solid state drives (SSDs), non-volatile memory express (NVMe), Persistent Memory (PMEM), quad-level cell (QLC)) processing power may be limited beyond the ability to handle input/output (I/O) traffic. Storage nodes 441-443 each include multiple physical storage components, which may include flash, SSD, NVMe, PMEM, and QLC storage solutions. For example, storage node 441 has storage 451, 452, 452, and 454; storage node 442 has storage 455 and 456; and storage node 443 has storage 457 and 458. In some examples, a single storage node may include a different number of physical storage components.

In the described examples, storage nodes 441-443 are treated as a SAN with a single global object, enabling any of objects 401-408 to write to and read from any of storage 451-458 using a virtual SAN component 432. Virtual SAN component 432 executes in compute nodes 421-423. Using the disclosure, compute nodes 421-423 are able to operate with a wide range of storage options. In some examples, compute nodes 421-423 each include a manifestation of virtualization platform 430 and virtual SAN component 432. Virtualization platform 430 manages the generating, operations, and clean-up of objects 401 and 402. Virtual SAN component 432 permits objects 401 and 402 to write incoming data from object 401 and incoming data from object 402 to storage nodes 441, 442, and/or 443, in part, by virtualizing the physical storage components of the storage nodes.

### Additional Examples

An example method of restoring a primary computing instance using a validated reputation cache comprises: creating a first virtual computing instance from a first backup of the primary computing instance; receiving, from a secondary computing device, first file reputation data for a plurality of files of the first virtual computing instance; storing the first file reputation data onto a secondary storage disk drive accessible by the first virtual computing instance; upon detection of malware on the first virtual computing instance from a first malware scan performed using the first file reputation data, creating a second virtual computing instance from a second backup of the primary computing instance; performing a second malware scan of the second virtual computing instance using the first file reputation data from the secondary storage disk drive; and upon detection of no malware on the second virtual computing instance, causing the second backup of the primary computing instance to be used as a recovery image to restore the primary computing instance.

An example computer system comprises a memory device; at least one processor executing one or more virtual machines; and a non-transitory computer readable medium having stored thereon program code executable by the at least one processor, the program code causing the at least one processor to: create a first virtual machine, the first virtual machine includes files restored from a first backup of a primary virtual machine; receive, from a secondary computing device, first security data for a plurality of files included in the first backup; store the first security data onto a disk drive accessible by the first virtual machine; upon detection of malware within the plurality of files from a first malware scan performed using the first security data, create a second virtual machine, the second virtual machine includes files restored from a second backup of the primary virtual machine; perform a second malware scan of the second virtual machine using the first security data from the disk drive; and upon detection of no malware on the second virtual machine, identify the second backup of the primary virtual machine to be used as a recovery image to restore the primary virtual machine.

An example non-transitory computer storage medium has stored thereon program code executable by a processor, the program code embodying a method comprising: creating a first virtual computing instance from a first backup of a primary computing instance; receiving, from a secondary computing device, first file reputation data for a plurality of files of the first virtual computing instance; storing the first file reputation data onto a secondary storage disk drive accessible by the first virtual computing instance; upon detection of malware on the first virtual computing instance from a first malware scan performed using the first file reputation data, creating a second virtual computing instance from a second backup of the primary computing instance; performing a second malware scan of the second virtual computing instance using the first file reputation data from the secondary storage disk drive; and upon detection of no malware on the second virtual computing instance, causing the second backup of the primary computing instance to be used as a recovery image to restore the primary computing instance.

Another example computer system comprises: a processor; and a non-transitory computer readable medium having stored thereon program code executable by the processor, the program code causing the processor to perform a method disclosed herein. Another example non-transitory computer storage medium has stored thereon program code executable by a processor, the program code embodying a method disclosed herein.

Alternatively, or in addition to the other examples described herein, examples include any combination of the following:
creating a virtual computing instance from a first backup of the primary computing instance;
receiving, from a secondary computing device, file reputation data for a plurality of files of a virtual computing instance;
storing the file reputation data onto a secondary storage disk drive accessible by a virtual computing instance;
creating a virtual computing instance from a second backup of a primary computing instance;
upon detection of malware on the first virtual computing instance from a first malware scan performed using the first file reputation data, creating a second virtual computing instance from a second backup of the primary computing instance;
performing a second malware scan of the second virtual computing instance using the first file reputation data from the secondary storage disk drive;
causing the second backup of the primary computing instance to be used as a recovery image to restore the primary computing instance;
upon detection of no malware on the second virtual computing instance, causing the second backup of the primary computing instance to be used as a recovery image to restore the primary computing instance;
creating a first checksum based on contents of the secondary storage disk drive at a first time;
transmitting the first checksum to another computing device;
creating a second checksum based on contents of the secondary storage disk drive at a second time;
transmitting the second checksum to the other computing device;
receiving a confirmation from the other computing device that the second checksum matches the first checksum;
using file reputation data from the secondary storage disk drive contingent upon the receiving of the confirmation;
creating the secondary storage disk drive as a virtual disk drive;
mounting the secondary storage disk drive to the first virtual computing instance;
mounting the secondary storage disk drive to the second virtual computing instance;
one or more of the first malware scan and the second malware scan includes a file-based checksum comparison;
creating a file checksum of a first file;
comparing the file checksum with an expected checksum associated with the first file identified by the first file reputation data;
a second backup of the primary computing instance includes one or more files not present in the first backup of the primary computing instance;
receiving, from the secondary computing device, second file reputation data for the one or more files;
performing the second malware scan of the second virtual computing instance further uses both the second file reputation data received from the secondary computing device and the first file reputation data from the secondary storage disk drive; storing the second file reputation data on the secondary storage disk drive along with the first file reputation data;
creating a third checksum based on contents of the secondary storage disk drive after storing the second file reputation data on the secondary storage disk drive;
transmitting the third checksum to another computing device for use validating use of the secondary storage disk drive during a subsequent malware scan of another backup of the primary computing instance;
computing instances are virtual machines;
computing instances are physical server devices;
computing instances are desktop computing devices;
virtual computing instances are virtual machines;
reputation data is security data;
a malware manager stores a checksum for a reputation cache;
a malware manager validates another checksum against a stored checksum;
a protected site executes protected devices;
protected devices are computing instances;
a storage site stores backups of protected devices;
a protected device has multiple backups stored at a storage site;
a backup system executes at the storage site and manages backups of protected devices;
security data includes expected checksums of files;
security data for particular files is identifiable by file path;
a protected device becomes infected with malware;
malware infection is detected on a protected device;
malware scan results are analyzed to determine whether a backup is infected with malware;
reputation data is requested from a malware manager;
security data is requested from a malware manager;
computing instances are deleted;
a next backup to analyze is determined based on a date/time of the backups;
identifying files that have reputation data stored on a reputation disk; and
identifying files that do not have reputation data stored on a reputation disk.

### Exemplary Operating Environment

The present disclosure is operable with a computing device (computing apparatus) according to an embodiment shown as a functional block diagram 500 in FIG. 5. FIG. 5 illustrates a block diagram of an example computing apparatus that may be used as a component of the architectures of FIG. 1 and FIG. 4. In an embodiment, components of a computing apparatus 518 are implemented as part of an electronic device according to one or more embodiments described in this specification. The computing apparatus 518 comprises one or more processors 519 which may be microprocessors, controllers, or any other suitable type of processors for processing computer executable instructions to control the operation of the electronic device. Alternatively, or in addition, the processor 519 is any technology capable of executing logic or instructions, such as a hardcoded machine. Platform software comprising an operating system 520 or any other suitable platform software may be provided on the computing apparatus 518 to enable application software 521 to be executed on the device. According to an embodiment, the operations described herein may be accomplished by software, hardware, and/or firmware.

Computer executable instructions may be provided using any computer-readable medium (e.g., any non-transitory computer storage medium) or media that are accessible by the computing apparatus 518. Computer-readable media may include, for example, computer storage media such as a memory 522 and communications media. Computer storage media, such as a memory 522, include volatile and non-volatile, removable, and non-removable media implemented in any method or technology for storage of information such as computer readable instructions, data structures, program modules or the like. Computer storage media include, but are not limited to, hard disks, RAM, ROM, EPROM, EEPROM, NVMe devices, persistent memory, phase change memory, flash memory or other memory technology, compact disc (CD, CD-ROM), digital versatile disks (DVD) or other optical storage, magnetic cassettes, magnetic tape, magnetic disk storage, shingled disk storage or other magnetic storage devices, or any other non-transmission medium (e., non-transitory) that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 522) is shown within the computing apparatus 518, it will be appreciated by a person skilled in the art, that the storage may be distributed or located remotely and accessed via a network or other communication link (e.g., using a communication interface 523). Computer storage media are tangible, non-transitory, and are mutually exclusive to communication media.

The computing apparatus 518 may comprise an input/output controller 524 configured to output information to one or more output devices 525, for example a display or a speaker, which may be separate from or integral to the electronic device. The input/output controller 524 may also be configured to receive and process an input from one or more input devices 526, for example, a keyboard, a microphone, or a touchpad. In one embodiment, the output device 525 also acts as the input device. An example of such a device may be a touch sensitive display. The input/output controller 524 may also output data to devices other than the output device, e.g., a locally connected printing device. In some embodiments, a user may provide input to the input device(s) 526 and/or receive output from the output device(s) 525.

The functionality described herein can be performed, at least in part, by one or more hardware logic components. According to an embodiment, the computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

Although described in connection with an exemplary computing system environment, examples of the disclosure are operative with numerous other general purpose or special purpose computing system environments or configurations. Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices.

Examples of the disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

Aspects of the disclosure transform a general-purpose computer into a special purpose computing device when programmed to execute the instructions described herein. The detailed description provided above in connection with the appended drawings is intended as a description of a number of embodiments and is not intended to represent the only forms in which the embodiments may be constructed, implemented, or utilized. Although these embodiments may be described and illustrated herein as being implemented in devices such as a server, computing devices, or the like, this is only an exemplary implementation and not a limitation. As those skilled in the art will appreciate, the present embodiments are suitable for application in a variety of different types of computing devices, for example, PCs, servers, laptop computers, tablet computers, etc.

The term “computing device” and the like are used herein to refer to any device with processing capability such that it can execute instructions. Those skilled in the art will realize that such processing capabilities are incorporated into many different devices and therefore the terms “computer”, “server”, and “computing device” each may include PCs, servers, laptop computers, mobile telephones (including smart phones), tablet computers, and many other devices. Any range or device value given herein may be extended or altered without losing the effect sought, as will be apparent to the skilled person. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

While no personally identifiable information is tracked by aspects of the disclosure, examples may have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” and “the” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A computerized method of restoring a primary computing instance using a validated reputation cache, the method comprising:
creating a first virtual computing instance (VCI) from a first backup of the primary computing instance;
receiving, from a secondary computing device, first file reputation data for a plurality of files of the first VCI;
storing the first file reputation data onto a secondary storage disk drive accessible by the first VCI;
performing a first malware scan of the first VCI using the first file reputation data from the secondary storage disk drive;
upon detection of malware from the first malware scan, creating a second VCI from a second backup of the primary computing instance;
performing a second malware scan of the second VCI using the first file reputation data from the secondary storage disk drive; and
upon detection of no malware on the second VCI, causing the second backup of the primary computing instance to be used as a recovery image to restore the primary computing instance.

2. The computerized method of claim 1, further comprising:
creating a first checksum based on contents of the secondary storage disk drive at a first time;
transmitting the first checksum to another computing device;
creating a second checksum based on contents of the secondary storage disk drive at a second time;
transmitting the second checksum to the other computing device; and
receiving a confirmation from the other computing device that the second checksum matches the first checksum,
wherein using the first file reputation data from the secondary storage disk drive is contingent upon the receiving of the confirmation.

3. The computerized method of claim 1, further comprising:
creating the secondary storage disk drive as a virtual disk drive;
mounting the secondary storage disk drive to the first VCI; and
mounting the secondary storage disk drive to the second VCI.

4. The computerized method of claim 1, wherein one or more of the first malware scan and the second malware scan includes a file-based checksum comparison that comprises:
creating a file checksum of a first file; and
comparing the file checksum with an expected checksum associated with the first file identified by the first file reputation data.

5. The computerized method of claim 1, wherein the second backup of the primary computing instance includes one or more files not present in the first backup of the primary computing instance, the method further comprising:
receiving, from the secondary computing device, second file reputation data for the one or more files,
wherein performing the second malware scan of the second VCI further uses both the second file reputation data received from the secondary computing device and the first file reputation data from the secondary storage disk drive.

6. The computerized method of claim 5, further comprising storing the second file reputation data on the secondary storage disk drive along with the first file reputation data.

7. The computerized method of claim 6, further comprising:
creating a third checksum based on contents of the secondary storage disk drive after storing the second file reputation data on the secondary storage disk drive; and
transmitting the third checksum to another computing device for use validating use of the secondary storage disk drive during a subsequent malware scan of another backup of the primary computing instance.

8. A computer system comprising:
a memory device;
at least one processor executing one or more virtual machines (VMs); and
a non-transitory computer readable medium having stored thereon program code executable by the at least one processor, the program code causing the at least one processor to:
create a first VM, the first VM includes files restored from a first backup of a primary VM;
receive, from a secondary computing device, first security data for a plurality of files included in the first backup;
store the first security data onto a disk drive accessible by the first VM;
upon detection of malware within the plurality of files from a first malware scan performed using the first security data, create a second VM, the second VM includes files restored from a second backup of the primary VM;
perform a second malware scan of the second VM using the first security data from the disk drive; and
upon detection of no malware on the second VM, identify the second backup of the primary VM to be used as a recovery image to restore the primary VM.

9. The computing system of claim 8, the program code further causing the at least one processor to:
create a first checksum based on contents of the disk drive;
transmit the first checksum to another computing device;
create a second checksum based on contents of the disk drive;
transmit the second checksum to the other computing device; and
receive a confirmation from the other computing device that the second checksum matches the first checksum,
wherein using the first security data from the disk drive in the second malware scan is contingent upon the receiving of the confirmation.

10. The computing system of claim 8, the program code further causing the at least one processor to:
create the disk drive as a virtual disk drive;
mount the disk drive to the first VM; and
mount the disk drive to the second VM.

11. The computing system of claim 8, wherein one or more of the first malware scan and the second malware scan includes a file-based checksum comparison that includes:
creating a file checksum of a first file; and
comparing the file checksum with an expected checksum associated with the first file identified by the first security data.

12. The computing system of claim 8, wherein the second backup of the primary VM includes one or more files not present in the first backup of the primary VM, the program code further causing the at least one processor to:
receive, from the secondary computing device, second security data for the one or more files,
wherein performing the second malware scan of the second VM further uses both the second security data received from the secondary computing device and at least some of the first security data from the disk drive.

13. The computing system of claim 12, the program code further causing the at least one processor to write the second security data to the disk drive along with the first security data.

14. The computing system of claim 13, the program code further causing the at least one processor to:
create a third checksum based on contents of the disk drive after storing the second security data on the disk drive; and
transmit the third checksum to another computing device for use validating use of the disk drive during a subsequent malware scan of another backup of the primary VM.

15. A non-transitory computer storage medium having stored thereon program code executable by a processor, the program code embodying a program code method comprising:
creating a first virtual computing instance (VCI) from a first backup of a primary computing instance;
receiving, from a secondary computing device, first file reputation data for a plurality of files of the first VCI;
storing the first file reputation data onto a secondary storage disk drive accessible by the first VCI;
upon detection of malware on the first VCI from a first malware scan performed using the first file reputation data, creating a second VCI from a second backup of the primary computing instance;
performing a second malware scan of the second VCI using the first file reputation data from the secondary storage disk drive; and
upon detection of no malware on the second VCI, causing the second backup of the primary computing instance to be used as a recovery image to restore the primary computing instance.

16. The non-transitory computer storage medium of claim 15, the program code method further comprising:
creating a first checksum based on contents of the secondary storage disk drive at a first time;
transmitting the first checksum to another computing device;
creating a second checksum based on contents of the secondary storage disk drive at a second time;
transmitting the second checksum to the other computing device; and
receiving a confirmation from the other computing device that the second checksum matches the first checksum,
wherein using the first file reputation data from the secondary storage disk drive is contingent upon the receiving of the confirmation.

17. The non-transitory computer storage medium of claim 15, wherein one or more of the first malware scan and the second malware scan includes a file-based checksum comparison that comprises:
creating a file checksum of a first file; and
comparing the file checksum with an expected checksum associated with the first file identified by the first file reputation data.

18. The non-transitory computer storage medium of claim 15, wherein the second backup of the primary computing instance includes one or more files not present in the first backup of the primary computing instance, the program code method further comprising:
receiving, from the secondary computing device, second file reputation data for the one or more files,
wherein performing the second malware scan of the second VCI further uses both the second file reputation data received from the secondary computing device and the first file reputation data from the secondary storage disk drive.

19. The non-transitory computer storage medium of claim 18, the program code method further comprising storing the second file reputation data on the secondary storage disk drive along with the first file reputation data.

20. The non-transitory computer storage medium of claim 19, the program code method further comprising:
creating a third checksum based on contents of the secondary storage disk drive after storing the second file reputation data on the secondary storage disk drive; and
transmitting the third checksum to another computing device for use validating use of the secondary storage disk drive during a subsequent malware scan of another backup of the primary computing instance.
